(19) United States
(12) Patent Application Publication
(10) Pub. No.: US 2005/0179843 A1
(43) Pub. Date: Aug. 18, 2005

(54) Method of aligning ferroelectric liquid crystal and method of manufacturing liquid crystal display using the aligning method

(75) Inventors: Joo-young Kim, Gyeonggi-do (KR); Yu-jin Kim, Gyeonggi-do (KR); Soon-young Hyun, Seoul (KR); Chang-ju Kim, Gyeonggi-do (KR); Jong-min Wang, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 11/025,070

(22) Filed: Dec. 30, 2004

(30) Foreign Application Priority Data
Feb. 13, 2004 (KR) 10-2004-0009624

(51) Int. Cl. G02F 1/1337

(52) U.S. Cl. 349/124

(57) ABSTRACT

A method of aligning an FLC using an ultraviolet irradiation is provided. In the method, the FLC includes a plurality of liquid crystal molecules each having a first group, and second through fourth groups arranged in a regular tetrahedron together with an axis of the first group centering on a chiral center, the method comprising: forming a photo-alignment layer on a substrate; and irradiating a polarized ultraviolet onto the photo-alignment layer formed on the substrate with an inclination angle, wherein an incident plane of the irradiated ultraviolet and the first group are not on the same plane but are perpendicular to each other, thereby bestowing a selectivity to one axis of the second through fourth groups. By aligning the CDR-FLC according to the present invention, and employing the aligned CDR-FLC in an LCD, the picture contrast ratio and the picture uniformity are enhanced.

### BACKGROUND OF THE INVENTION

Priority is claimed to Korean Patent Application No. 2004-9624, filed on Feb. 13, 2004, in the Korean Intellectual Property Office, the disclosure of which is incorporated herein in its entirety by reference.

1. Field of the Invention

The present invention relates to a method of aligning a liquid crystal, and more particularly, to a method of aligning a ferroelectric liquid crystal (FLC) using an ultraviolet irradiation.

2. Description of the Related Art

Compared with nematic liquid crystal, ferroelectric liquid crystal (FLC) exhibits a very fast response rate due to spontaneous polarization caused when an electric field is applied. To this end, many research efforts have been performed regarding the FLC as a next generation liquid crystal material of an active matrix (AM) LCD requiring a moving picture response characteristic considerable to a CRT.

Unlike the nematic liquid crystal, the FLC has a chiral center in a liquid crystal molecule, and has an advantage of a fast response rate due to existing spontaneous polarization. The FLC is classified into a surface stabilized FLC (SS-FLC), a continuous director rotation FLC (CDR-FLC) and the like.

In the SS-FLC, when a voltage is not applied to liquid crystal molecules, the SS-FLC exhibits bistability in which the liquid crystal molecules are left for a long time with the same probability with respect to a state of θ or −θ. The SS-FLC is known to have a fast response rate, but it is very difficult to control the SS-FLC by a continuous gray scale due to a very high temperature dependence and a sticking problem.

Unlike the SS-FLC, the CDR-FLC exhibits a phase transition of Iso-N*(chiral nematic)-SmC*(Smectic C*)-crystal. Since the CDR-FLC always has a bookself structure unlike the SS-FLC, it exhibits a high optical efficiency but does not exhibit zigzag defects. Also, since the CDR-FLC has a monostable structure and not a bistable structure, it has an advantage in that it is possible to realize an analog gray scale.

Also, in the CDR-FLC, it is necessary to apply a proper voltage near a phase transition temperature between the chiral nematic phase (N*) and the chiral smectic C phase (SmC*) in order to align the liquid crystal. However, although there exists a difference depending on a material and a recipe, an inherent stripe texture occurs as the CDR-FLC is cooled to a room temperature, so that brightness in black state increases and contrast ratio is lowered.

To solve the above drawbacks, Yasufumi et al. disclose a paper related to a use of a rubbing process entitled “Novel Ferroelectric Liquid Crystal Mode for Active Matrix Liquid Crystal Display using Cholesteric-Chiral Smectic C Phase Transition in Japanese Journal of Applied Physics Vol. 38 (1999) pp. 5977-5938.

This paper reports a case of minimizing the stripe texture at room temperature by changing the material and rubbing condition of the alignment film. The aforementioned drawbacks in the aligning of the FLC using ultraviolet or visible ray are not yet solved.

### SUMMARY OF THE INVENTION

The present invention provides a method of aligning an FLC capable of providing selectivity with respect to a sub-axis of the FLC, and a ferroelectric liquid crystal display manufactured by the aligning method.

According to an aspect of the present invention, there is provided a method of aligning an FLC, the FLC includes a plurality of liquid crystal molecules each having a first group, and second through fourth groups arranged in a regular tetrahedron together with an axis of the first group centering on a chiral center, the method comprising: forming a photo-alignment layer on a substrate; and irradiating a polarized ultraviolet onto the photo-alignment layer formed on the substrate with an inclination angle, wherein an incident plane of the irradiated ultraviolet and the first group are not on the same plane but are perpendicular to each other, thereby bestowing a selectivity to one axis of the second through fourth groups.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a method of aligning an FLC according to an embodiment of the present invention;

FIG. 2 is a sectional view taken along an X-Z plane of FIG. 1; and

FIG. 3 is a sectional view taken along a Y-Z plane of FIG. 1.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

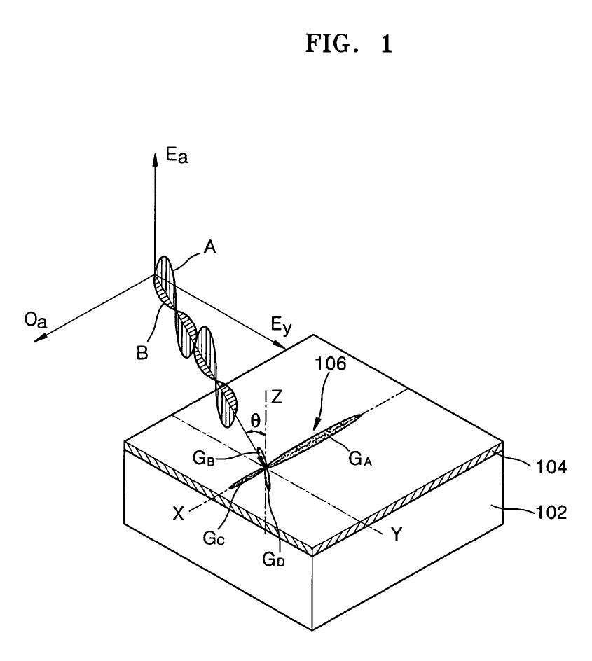

FIG. 1 is a schematic view illustrating a method of aligning an FLC according to an embodiment of the present invention.

Referring to FIG. 1, the FLC is formed on a transparent substrate 102 and an alignment layer 104.

The alignment layer 104 is formed on the transparent substrate 102 by a spin method or a printing method, and an alignment property is bestowed by irradiating a polarized ultraviolet onto the formed alignment layer 104. Thereafter, another substrate manufactured by the same method is prepared and assembled with the previously manufactured substrate 102 to face each other, thereby manufacturing an LC cell, and an FLC is injected into a space between the assembled two substrates.

In a preferred embodiment, to align the alignment layer 104, an alignment material is coated to a thickness of 100 Å to 1,000 Å on a transparent substrate 102 made of indium tin oxide (ITO), thereby forming an alignment layer 104, and a ultraviolet light having a wavelength of 200 nm to 400 nm and an energy of 100 mJ/cm² to 2,000 mJ/cm² is polarized and irradiated onto the formed alignment layer 104. When like treated substrates are assembled as mentioned above, the result is an LC cell having a cell gap of 0.5 μm to 2 μm, for example. The FLC used in the preferred embodiment is formed of CDR-FLC.

Since the FLC is formed of CDR-FLC, it has a chiral center Cc and biaxiality, unlike the conventional nematic liquid crystal having uniaxiality. In other words, liquid crystal molecules 106 of the FLC include the chiral center Cc and first through fourth groups G_{A}, G_{B}, G_{C} and G_{D}.

In more detail, an axis formed by a center of the first group G_{A} is a main axis nₑ, which corresponds to an extraordinary axis of the conventional nematic liquid crystal. The second through fourth groups G_{B}, G_{C} and G_{D} are arranged in a regular tetrahedron together with the main axis nₑ, centering on the chiral center.

Also, according to a preferred embodiment of the present invention, a polarization ratio of the irradiated ultraviolet is preferably 10:1 through 30:1.

In the irradiation process for optically aligning the conventional nematic liquid crystal, since the extraordinary axis corresponding to the main axis of the liquid crystal molecule exists on an irradiation plane formed by an incident light and a vector perpendicular to a substrate, a method in which an alignment direction of liquid crystal molecules is determined by a polarization direction and a pretilt angle is controlled by an incident angle and the applied irradiation energy. However, in the FLC, it is known that when a pretilt angle of a main axis of liquid crystal molecule is very low and axis direction nₒ of the second group G_{B} exists, a better alignment characteristic is obtained. Also, different kinds of moieties form a sub-axis centering on the chiral center. Hence, in embodiments of the present invention, the main axis of the FLC is optically aligned by a polarization direction unlike in the nematic liquid crystal such that the alignment direction of the main axis of the liquid crystal molecule is perpendicular to an incident plane, thereby bestowing a selectivity with respect to the sub-axis and enhancing the alignment characteristic of the FLC.

An irradiation light is irradiated onto the alignment layer 104 with an incident angle of θ. At this time, a polarized light A determines a direction that the first group G_{A} of liquid crystal molecules is aligned on a surface of the alignment layer 104. In other words, the main axis ne of the first group GA is arranged in an X-axis direction perpendicular to the polarized light A occupying most of an illumination intensity of the incident irradiation light.

For instance, when the photo-alignment layer is formed of cinnamate-based material, it is preferable that the irradiation light has a ratio of P wave to S wave ranging from 10:1 to 30:1. In this case, the P wave has a polarization direction parallel to the incident plane, and the S wave has a polarization direction perpendicular to the incident plane. Also, a main axis Ga can be aligned while bestowing the selectivity using a P wave component, and can bestow the selectivity to one of sub-axes Gb through Gd using an S wave component.

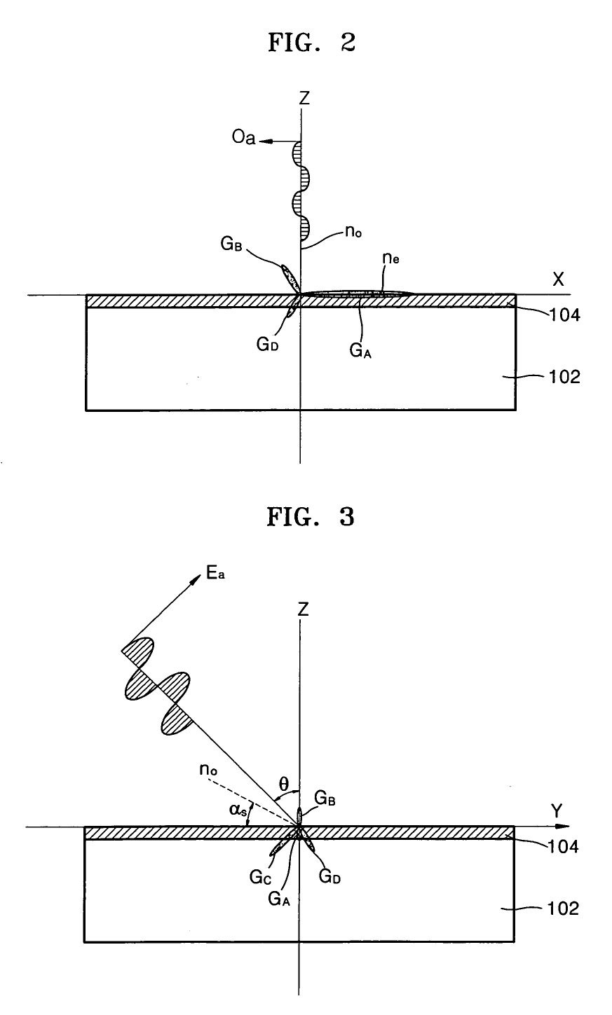

FIG. 2 is a sectional view taken along an X-Z plane of FIG. 1.

Referring to FIG. 2, the pretilt angle between the main axis nₑ of the first group G_{A} and a surface of the alignment layer 104 is controllable by a combination of an incident angle θ of the irradiation light and the irradiation energy only when the plane of incidence of the incident irradiation light is on the same plane as the main axis nₑ of the first group G_{A}. Accordingly, in preferred embodiments of the present invention, since the irradiation light is incident perpendicularly to the main axis nₑ of the first group G_{A}, the pretilt angle between the main axis nₑ of the first group G_{A} and the plane of the alignment layer 104 is 0°.

FIG. 3 is a sectional view taken along a Y-Z plane of FIG. 1.

Referring to FIG. 3, there will be described examples that the alignment selectivity is bestowed in the sub-axis direction to the second group G_{B}, which is one of the second through fourth groups G_{B}, G_{C} and G_{D}. In the preferred embodiments of the present invention, the sub-axis is defined as an axis direction near the second group G_{B} on the Y-Z plane perpendicular to the main axis nₑ.

According to the preferred embodiments of the present invention, a direction that the axis direction nₒ of the second group G_{B} is aligned on the plane of the alignment layer 104 is determined by a polarization component B of the irradiation light. In other words, since the direction is determined to be a direction perpendicular to the polarization component B of the irradiation light, the axis direction nₒ of the second group G_{B} is arranged on the Y-Z plane perpendicular to the plane of the alignment layer 104.

Also, a pretilt angle αₛ between the axis direction no of the second group G_{B} and the plane of the alignment layer 104 is controllable by a combination of an irradiation energy of the polarization component B of the irradiation light and the incident angle θ of the irradiation light.

An embodiment described below corresponds to an experimental example in which the pretilt angle αₛ between the axis direction no of the second group G_{B} and the plane of the alignment layer 104 is controlled.

### Embodiment

Photo-alignment layer 104 was formed using a cinnamate based photo-alignment material using stylene/hydroxyphenylmaleimide copolymer. Specifically, the photo-alignment material is dissolved in NMP at a concentration of 5 wt %, is coated on two ITO glass substrates each having a size of 1.5 cm×1.5 cm, and is then dried on a heating plate for 1 hour, thereby forming an alignment layer at a thickness of 400 Å.

A cinnamatic photo-alignment material disclosed in U.S. Pat. No. 6,218,501 entitled “Polymaleimide and Polyimide Photo-Alignment Materials for LC Display” used as a cited reference of this application and assigned to the inventors, KIM et al. of the present invention, is preferably used as the photo-alignment layer 104 of the present invention. The content of this patent is herein incorporated by reference.

Meanwhile, a polarized ultraviolet was irradiated onto two transparent ITO substrates each coated with the aforementioned photo-alignment layer at an incident angle θ of 30° at an energy of 500 mJ/cm² in the method shown in FIG. 1. Thereafter, a thermosetting sealant mixed with a 2 wt % spacer having a size of 1.5 μm was coated on one of the two irradiated substrates by a screen printing method. Then, the two substrates are attached and are pressed and thermally cured at 150° C. for 1 hour using a hot press, thereby manufacturing an LC cell. At this time, the LC cell was manufactured such that an injection direction of liquid crystal was perpendicular to an alignment direction.

The manufactured LC cell was loaded on a Mattler hot stage set at 110° C., and a small amount of CDR-FLC was dropped on an injection inlet such that the CDR-FLC was injected in an isotropic state. After the injection of the CDR-FLC was completed, the LC cell was cooled to 74° C. that is a temperature just before a phase transition and was slowly cooled by 0.2° C. per minute in a section of the phase transition temperature±1° C. and DC 2V was applied. After the phase transition was completed, the LC cell was slowly cooled to 40° C. at a cooling rate of 1° C. per minute, and the contrast ratio was measured at 40° C. using an optical powermeter. A black brightness was measured as a brightness when 0V was applied, and a white brightness was measured when Vpp 10V was applied at a frequency of 360 Hz. After the measurements of the brightness were completed, the contrast ratio was computed. Total 10 LC cells were manufactured by the above method and contrast ratios of them were computed.

### COMPARATIVE EXAMPLE

SE-7992 alignment material that is a rubbing alignment layer made by a Japanese Nissan Chemical Co. Ltd. is coated on two ITO transparent substrates each having a size of 1.5 cm×1.5 cm by a spin coating method, and is then dried on a heating plate maintained at 200° C. for 1 hour, thereby forming an alignment layer at a thickness of 400 Å. The SE-7992 alignment material is a polyimide-based alignment material. The two ITO transparent substrates each coated with the polyimide alignment layer were aligned by a rubbing method. Thereafter, a thermosetting sealant mixed with a 2 wt % spacer having a size of 1.5 μm was coated on one of the two substrates by a screen printing method. Then, the two substrates are attached, and are pressed and thermally cured at 150° C. for 1 hour using a hot press, thereby manufacturing an LC cell. At this time, the LC cell was manufactured such that an injection direction of liquid crystal was perpendicular to an alignment direction.

The manufactured LC cell was loaded on a Mattler hot stage set at 110° C., and a small amount of CDR-FLC was dropped on an injection inlet such that the CDR-FLC was injected in an isotropic state. After the injection of the CDR-FLC was completed, the LC cell was cooled to 74° C. that is a temperature just before a phase transition and was slowly cooled by 0.2° C. per minute in a section of the phase transition temperature±1° C. and DC 2V was applied. After the phase transition was completed, the LC cell was slowly cooled to 40° C. at a cooling rate of 1° C. per minute, and the contrast ratio was measured at 40° C. using an optical powermeter. A black brightness was measured as a brightness when 0V was applied, and a white brightness was measured when Vpp 10V was applied at a frequency of 360 Hz. After the measurements of the brightness were completed, the contrast ratio was computed. A total of ten (10) LC cells were manufactured by the above method and contrast ratios of them were computed.

Referring to the below Table 1, it is understood that the contrast ratio of the embodiment is enhanced two times or more higher than that of the comparative example.

TABLE 1

| Cell No. | Embodiment | Comparative Example |
|---|---|---|
| 1 | 483 | 238 |
| 2 | 455 | 193 |
| 3 | 468 | 221 |
| 4 | 467 | 214 |
| 5 | 479 | 195 |
| 6 | 491 | 219 |
| 7 | 488 | 204 |
| 8 | 471 | 231 |
| 9 | 469 | 229 |
| 10 | 287 | 209 |
| Average | 475.8 | 215.3 |

Meanwhile, according to the preferred embodiment of the present invention, when the aligned transparent substrates are combined and manufactured to the LC cell, the alignment direction of the liquid crystal is made to be perpendicular to the injection direction of the liquid crystal, thereby maximizing the effect of the irradiation process.

By using the aforementioned alignment process and the cell combination, the selectivity of the alignment can be bestowed in the direction perpendicular to the main axis not the main axis direction. Also, when the liquid crystal is injected by the aforementioned method and the LCD is manufactured, defects due to the stripe texture are minimized, thereby enhancing the display quality.

As described above, according to the present invention, CDR-FLC is aligned according to the preferred embodiment of the present invention, and is used in an LCD, thereby enhancing the picture contrast ratio and the picture uniformity.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of aligning an FLC using a photo-alignment, the FLC including a plurality of liquid crystal molecules each having a first group, and second through fourth groups arranged in a regular tetrahedron together with an axis of the first group centering on a chiral center, the method comprising:
forming a photo-alignment layer on a substrate; and
irradiating a polarized ultraviolet onto the photo-alignment layer formed on the substrate with an inclination angle,
wherein an incident plane of the irradiated ultraviolet light and the first group are not on the same plane but are perpendicular to each other, thereby bestowing a selectivity to one axis of the second through fourth groups.

2. The method of claim 1, wherein the irradiated ultraviolet has a polarization ratio ranging from 10:1 to 30:1.

3. The method of claim 1, wherein the photo-alignment layer is made of a photodimerization type photo-alignment material represented by cinnamate-based or coumarin-based alignment material.

4. The method of claim 1, wherein the irradiated ultraviolet light has an incident plane, which is perpendicular to the axis of the first group such that the axis of the first group is parallel to the photo-alignment layer.

5. The method of claim 1, wherein the irradiated ultraviolet has an incident surface, which is perpendicular to the axis of the first group such that the axis of the first group is parallel to the substrate.

6. The method of claim 1, wherein the one axis of the second through fourth groups is an axis of the second group.

7. A method of manufacturing an LCD including an FLC aligned by the method of claim 1, the method comprising:
injecting the FLC in a direction perpendicular to the axis direction of the first group.

8. The method of claim 7, wherein the FLC is injected in an isotropic state, and is then slowly cooled at a cooling rate of 0.1° C. to 0.5° C. per minute.

9. The method of claim 8, wherein a DC 2V to 3V is applied at the same time with the cooling, and after a phase transition is completed, the DC is eliminated and the FLC is slowly cooled to room temperature.

10. A method of manufacturing an LCD including an FLC aligned by the method of claim 2, the method comprising:
injecting the FLC in a direction perpendicular to the axis direction of the first group.

11. The method of claim 10, wherein the FLC is injected in an isotropic state, and is then slowly cooled at a cooling rate of 0.1° C. to 0.5° C. per minute.

12. The method of claim 11, wherein a DC 2V to 3V is applied at the same time with the cooling, and after a phase transition is completed, the DC is eliminated and the FLC is slowly cooled to room temperature.

13. A method of manufacturing an LCD including an FLC aligned by the method of claim 3, the method comprising:
injecting the FLC in a direction perpendicular to the axis direction of the first group.

14. The method of claim 13, wherein the FLC is injected in an isotropic state, and is then slowly cooled at a cooling rate of 0.1° C. to 0.5° C. per minute.

15. The method of claim 14, wherein a DC 2V to 3V is applied at the same time with the cooling, and after a phase transition is completed, the DC is eliminated and the FLC is slowly cooled to room temperature.
